(19) United States
(12) Patent Application Publication
(10) Pub. No.: US 2026/0074920 A1
(43) Pub. Date: Mar. 12, 2026

(54) SYSTEM AND METHOD TO EVALUATE IDENTITY OF NON-DIGITAL ASSET VIA DISTRIBUTED LEDGER

(71) Applicant: Quotidian Engineering and Development Corp., Lewes, DE (US)

(72) Inventors: Stuart W. Card, Newport, NY (US); Leigh R. Keno, Mohawk, NY (US); Joseph R. McCoy, Frankfort, NY (US); Christopher M. Smolen, Oneida, NY (US); Yuchao Zhou, Monero Valley, CA (US)

(21) Appl. No.: 19/322,194

(22) Filed: Sep. 8, 2025

Related U.S. Application Data
(60) Provisional application No. 63/691,762, filed on Sep. 6, 2024.

(51) Int. Cl. H04L 9/32

(52) U.S. Cl. CPC H04L 9/3271

(57) ABSTRACT

The disclosure relates to evaluating a non-digital asset via a distributed ledger. The method includes issuing a challenge to a custodian of an object purported to be a non-digital asset based on a digital fingerprint. The digital fingerprint includes a plurality of characteristics for the non-digital asset encrypted and stored on a distributed ledger. The method includes determining whether a response to the challenge includes a predetermined set of characteristics of the object. In response to determining the predetermined set of characteristics is not consistent with the set of corresponding characteristics, a cost to issue a subsequent challenge request for the object increases. In response to determining the predetermined set of characteristics of the object is consistent with the set of corresponding characteristics, the object is confirmed as being the non-digital asset.

### TECHNICAL FIELD

The technology relates to using techniques to evaluate the identity of a non-digital asset via a distributed ledger.

### BACKGROUND

Non-digital assets, including physical objects such as art and antiquities, may be faked, forged, or stolen. Furthermore, owners of old, historic, and potentially valuable objects are often interested in authentication and appraisal of worth for tax or insurance purposes.

The “provenance” of an object is a chronology of the sequences of the object's formal ownership, custody, and places of storage. For museums and the art trade, in addition to helping establish the authorship and authenticity of an object, provenance has become increasingly important in helping establish the moral and legal validity of a chain of custody.

Manually evaluating the identity of an asset can be a laborious, inexact, and time consuming effort. And any computer-based system that may be developed may be susceptible to fraud, hacking, or other misuse. Conventional technological systems and methods attempting to confirm the identity of objects remain susceptible to the these limitations, even when relying upon higher fidelity image recognition and/or processing techniques.

### SUMMARY

The illustrative aspects of the present disclosure are designed to solve the problems herein described and/or other problems not discussed.

Aspects of the present disclosure relate to evaluating a non-digital asset via a distributed ledger. Issues associated with conventional technologies are addressed by the subject matter of the independent claims included in the disclosure. Additional aspects are included in the dependent claims.

In one aspect, the present disclosure provides a method including: issuing a challenge to a custodian of an object purported to be a non-digital asset based on a digital fingerprint of the non-digital asset, wherein the digital fingerprint includes a plurality of characteristics for the non-digital asset encrypted and stored on a distributed ledger; determining whether a response to the challenge includes a predetermined set of characteristics of the object consistent with a set of corresponding characteristics of the digital fingerprint; in response to determining the predetermined set of characteristics of the object is not consistent with the set of corresponding characteristics of the digital fingerprint, increasing a cost to the custodian to issue a subsequent challenge request for the object; and in response to determining the predetermined set of characteristics of the object is consistent with the set of corresponding characteristics of the digital fingerprint, confirming the object as being the non-digital asset.

Further aspects of the disclosure provide a system including: a processor; and a memory having programming instructions configured to cause the processor to perform actions including: issuing a challenge to a custodian of an object purported to be a non-digital asset based on a digital fingerprint of the non-digital asset, wherein the digital fingerprint includes a plurality of characteristics for the non-digital asset encrypted and stored on a distributed ledger; determining whether a response to the challenge includes a predetermined set of characteristics of the object consistent with a set of corresponding characteristics of the digital fingerprint; in response to determining the predetermined set of characteristics of the object is not consistent with the set of corresponding characteristics of the digital fingerprint, increasing a cost to the custodian to issue a subsequent challenge request for the object; and in response to determining the predetermined set of characteristics of the object is consistent with the set of corresponding characteristics of the digital fingerprint, confirming the object as being the non-digital asset.

Additional aspects of the disclosure include a program product including a computer readable storage medium with program code for causing a computer system to perform actions including: issuing a challenge to a custodian of an object purported to be a non-digital asset based on a digital fingerprint of the non-digital asset, wherein the digital fingerprint includes a plurality of characteristics for the non-digital asset encrypted and stored on a distributed ledger; determining whether a response to the challenge includes a predetermined set of characteristics of the object consistent with a set of corresponding characteristics of the digital fingerprint; in response to determining the predetermined set of characteristics of the object is not consistent with the set of corresponding characteristics of the digital fingerprint, increasing a cost to the custodian to issue a subsequent challenge request for the object; and in response to determining the predetermined set of characteristics of the object is consistent with the set of corresponding characteristics of the digital fingerprint, confirming the object as being the non-digital asset.

Implementations of the disclosure may include one or more of the following optional features:
Generating the digital fingerprint of the non-digital asset by encrypting and storing the plurality of characteristics on the digital ledger;
In response to the predetermined set of characteristics of the object is consistent with the set of corresponding characteristics of the digital fingerprint: transferring the non-digital asset to the custodian; and recording a transfer of rights to the non-digital asset on the distributed ledger, wherein the recorded transfer of rights includes a proof of rights transfer;
In response to determining the predetermined set of characteristics of the object is not consistent with the set of corresponding characteristics of the digital fingerprint, transferring an asset from a digital wallet associated with the custodian;
Updating the digital fingerprint to remove data from at least one of processing artifacts, irrelevant data, or measurement variations;
Estimating an effectiveness of the digital fingerprint based on a quantity and/or type of the plurality of characteristics of the non-digital asset included in the digital fingerprint;
In response to the effectiveness of the digital fingerprint not meeting an effectiveness threshold, adding additional characteristics of the non-digital asset to the digital fingerprint; and/or

In response to determining the predetermined set of characteristics of the object is not consistent with the set of corresponding characteristics of the digital fingerprint, storing the response to the challenge on the distributed ledger.

### BRIEF DESCRIPTION OF THE DRAWINGS

Other aspects, advantages and novel features of the disclosure will become more apparent from the following detailed description of the disclosure when considered in conjunction with the accompanying drawings, which are incorporated into the disclosure and form a part of the disclosure, wherein:

FIG. 1 shows a schematic view of components for implementing systems and methods for automated assessment of objects according to the disclosure;

FIGS. 2 and 3 show schematic views of applying a system architecture for implementing methods and systems of the disclosure;

FIG. 4 provides an illustrative block diagram of example computer hardware for implementing systems and methods according to the disclosure;

FIGS. 5 and 6 provides a schematic diagram of a machine learning model for evaluating a response to a challenge and/or creating digital fingerprints in embodiments of the disclosure; and

FIG. 7 provides an illustrative flow diagram of an example methodology for implementing methods according to the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments disclosed herein were chosen and described to best explain the principles of the disclosure and the practical application, and to enable others of ordinary skill in the art to understand the disclosure for various embodiments with various modifications as are suited to the particular use contemplated.

The disclosure describes system, apparatus, device, and/or method embodiments, and/or combinations and sub-combinations of any of the above, for evaluating the provenance of an object. While preferred embodiments of the disclosure are disclosed in the attached materials, many other implementations will occur to one of ordinary skill in the art and are all within the scope of the disclosure. Each of the various embodiments described may be combined with other described embodiments in order to provide multiple features. Furthermore, while the attached materials describe a number of separate embodiments of the apparatus and method of the present disclosure, what has been described is merely illustrative of the application of the principles of the present disclosure. Other arrangements, methods, modifications, and substitutions by one of ordinary skill in the art are therefore also considered to be within the scope of the present invention.

In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left, and right, are for illustrative purposes only and can be varied within the scope of the disclosure. For example, the references “upper” and “lower” are relative and used only in the context to the other and are not necessarily “superior” and “inferior.” Generally, similar spatial references of different aspects or components indicate similar spatial orientation and/or positioning, i.e., that each “first end” is situated on or directed towards the same end of the device.

Some embodiments will now be described with reference to the figures. Like elements in the various figures may be referenced with like numbers for consistency. In the following description, numerous details are set forth to provide an understanding of various embodiments and/or features.

The disclosure relates to evaluating a non-digital asset via a distributed ledger. The method includes issuing a challenge to a custodian of an object purported to be a non-digital asset based on a digital fingerprint. The digital fingerprint includes a plurality of characteristics for the non-digital asset encrypted and stored on a distributed ledger. The method includes determining whether a response to the challenge includes a predetermined set of characteristics of the object. In response to determining the predetermined set of characteristics is not consistent with the set of corresponding characteristics, a cost to issue a subsequent challenge request for the object increases. In response to determining the predetermined set of characteristics of the object is consistent with the set of corresponding characteristics, the object is confirmed as being the non-digital asset.

The desire to confirm or otherwise evaluate the identity of a non-digital asset may arise in several different situations. For example, a customer may want to buy an object, but only after confirming that the seller actually has the right to sell the object. This may entail determining that the object has a clear chain of title, with ownership vested in the seller (or, e.g., in the case of sale on consignment, that the seller is acting as an agent for an entity with rights to possess the object). It may also entail evaluating the identity of the object, i.e., determining that the object being offered for sale is authentic, i.e., the specific object referenced by the chain of title. In this way, the buyer can have greater confidence that the seller is the legal owner of the object with full rights to transfer ownership. In another example, law enforcement agents may want to return an object, e.g., obtained during an arrest and/or seizure, to its rightful owner and/or rightful possessor (e.g., in the case of a museum having the rights to display the object, etc.)

Some embodiments will now be described with reference to the figures. Like elements in the various figures may be referenced with like numbers for consistency. In the following description, numerous details are set forth to provide an understanding of various embodiments and/or features.

Non-digital assets, including physical objects such as art and antiquities, may be faked, forged, or stolen. Furthermore, owners of old, historic, and potentially valuable objects are often interested in authentication and appraisal of worth for tax or insurance purposes.

The “provenance” of an object is a chronology of the sequences of the object's formal ownership, custody, and places of storage. For museums and the art trade, in addition to helping establish the authorship and authenticity of an object, provenance has become increasingly important in helping establish the moral and legal validity of a chain of custody.

Manually evaluating the identity of an asset can be a laborious, inexact, and time consuming effort. And any computer-based system that may be developed may be susceptible to fraud, hacking, or other misuse. Conventional technological systems and methods attempting to confirm the identity of objects remain susceptible to these limitations, even when relying upon higher fidelity image recognition and/or processing techniques.

Human experts may play a role in evaluating objects, e.g., to determine fake or counterfeit objects. However, experts cannot generally identify whether a particular object is what it is purported to be without relying on the current holder (i.e., owner or other lawful possessor(s)) of the object. Furthermore, expert analysis can be time consuming and expensive when accounting for multiple factors, e.g., travel time. The systems and methods disclosed herein provide a technical solution to identifying objects without the need for an expert at the time of identification. The systems and methods are herein suitable for use over a network, obviating the need for expert travel or shipping the object to an expert, thus providing rapid confirmation for parties acting in good faith. Furthermore, the systems and methods disclosed herein include safeguards against bad actors attempting to undermine the process. Embodiments of the disclosure can extend beyond confirmation of identity to include transfer of ownership and recording the transfer immutably on a distributed ledger.

The disclosure relates to evaluating a non-digital asset via a distributed ledger. The method includes issuing a challenge to a custodian of an object purported to be a non-digital asset based on a digital fingerprint. The digital fingerprint includes a plurality of characteristics for the non-digital asset encrypted and stored on a distributed ledger. The method includes determining whether a response to the challenge includes a predetermined set of characteristics of the object. In response to determining that the predetermined set of characteristics is not consistent with the set of corresponding characteristics, a cost to issue a subsequent challenge request for the object increases. In response to determining that the predetermined set of characteristics of the object is consistent with the set of corresponding characteristics, the object is confirmed as being the non-digital asset.

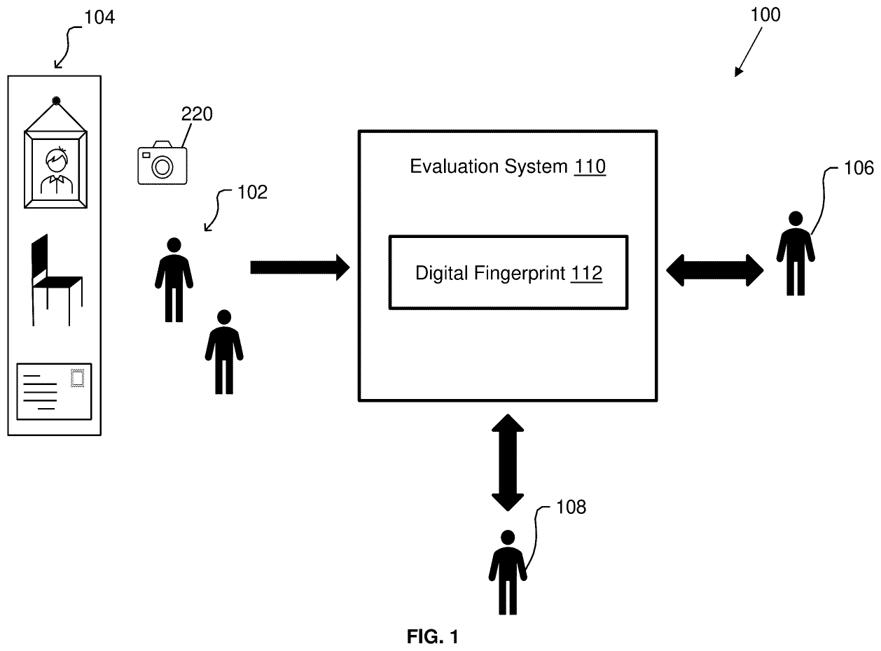

FIG. 1 shows an environment 100 for confirming the identity of a non-digital asset 104 (simply “asset” hereafter). Asset 104 may be, as non-limiting examples, an artistic work, such as a painting, sculpture, photograph, etc. Asset 104 may additionally or alternatively be an antique and/or valuable object, such as a vase, a piece of furniture, glassware, a car, or the like. Asset 104 in other scenarios may be a collectible item, such as a trading card, stamp, coin, book, print, toy, sports memorabilia, and so forth. Asset 104, in still further examples, may also be comparatively mundane but uniquely identifiable. In some cases, asset 104 may correspond to several of these categories. Asset 104 may be owned by, or otherwise accessible to, a lawful holder 106 (e.g., owner, lessee, caretaker, borrower, etc.). That is, holder 106 may be any one person, group of people, business entity, etc., with lawful access to asset 104.

Environment 100 also may include one or more experts 102 (i.e., individuals, groups of people, legal entities, etc.) who are able to physically examine asset 104 to determine characteristics of asset 104. In particular, experts 102 may be able to identify physical characteristics that are sufficiently unique to asset 104, and which may be used to identify asset 104. Example characteristics may include, without limitation, dimensions, weight, materials, images (e.g., comprehensive high-resolution images), patina, craquelure, wear patterns, evidence of natural phenomena such as water damage, fading, other non-public specialized characteristics, including microscopic and macroscopic features. Characteristics may also include information from sophisticated analysis, such as x-ray imaging, microscopy, mass spectroscopy, infrared reflectography, pigment (or other chemical) analysis, and so forth. The aggregate of these characteristics can be the basis for evaluating whether asset 104 is genuine, the value of asset 104, and/or other qualities of asset 104. In embodiments of the disclosure, experts 102 may provide this information to an evaluation system 110 (described in more detail herein).

Holder 106 may provide information to the evaluation system 110. In particular, holder 106 may provide title documents, a bill of sale, or other proof of ownership of asset 104 to evaluation system 110. Evaluation system 110 may record the proof of ownership along with other information regarding asset 104. As described in greater detail below, evaluation system 110 may maintain this information in an encrypted and/or immutable form. In an example embodiment, evaluation system 110 records the proof of ownership and any encrypted information of asset 104 (e.g., in the form of a cryptographic hash) on a distributed digital ledger, such as a blockchain. The stored information of asset 104 may be known as a digital fingerprint 112. In this arrangement, the proof of ownership is public, distributed, and immutable, and any known properties may similarly be encrypted and immutable. Being encrypted, certain properties or subsets of properties of asset 104 cannot easily be guessed and/or altered without detection.

Another person, group of people, legal entity, etc., may be interested in determining whether an object of interest is genuinely asset 104, the value of asset 104, and/or other information relating to asset 104. Such entities are referenced collectively herein as a custodian 108 of an object purported to be asset 104. Custodian 108 may be interested in possessing, or otherwise may come into possession of, asset 104. For example, custodian 108 may be interested in purchasing asset 104 from holder 106. Alternatively, custodian 108 may have recovered a lost or stolen asset 104 and may want to return it to its rightful owner. In still other instances, holder 106 and evaluation requester 108 may be the same entity. In yet additional instances, expert(s) and/or evaluation requester 108 may be the same entity.

In these and other circumstances, the custodian 108 may be able to examine asset 104 and identify characteristics of the object, e.g., similar to how the human expert(s) 102 previously identified sufficiently unique characteristics. Expert(s) 102, holder 106, and/or evaluation system 110 (e.g., by automatic action) may issue a challenge to custodian 108. The custodian 108 may provide this information to the evaluation system 110, requesting evaluation of the identity of asset 104. If evaluation system 110 determines that the characteristics provided by the custodian 108 match the fingerprint of the object, the evaluation system 110 confirms that asset 104 matches the stored fingerprint.

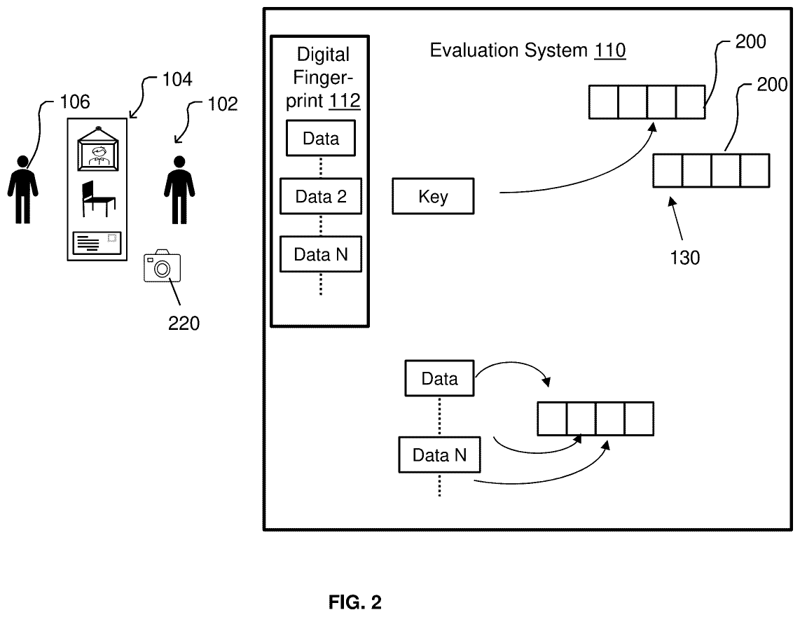

Referring to FIG. 2, operational details of evaluation system 110 are discussed. One or more experts 102 may examine asset 104 to generate fingerprint 112 based on various properties, including unique aspects and/or characteristics of asset 104 as discussed herein. Expert 102 may provide any number (N) of data items representing various characteristics of asset 104. Collectively, these data items make up fingerprint 112 of asset 104, i.e., a data structure that uniquely identifies the object for all practical purposes. These data are encrypted and committed to a distributed digital ledger 200 to preserve the fingerprint's secrecy. In some examples, e.g., to save space on ledger 200, a hash or other reliable representation or summary of the data is stored on ledger 200 in lieu of the data. If so, the data can later be verified against the hash, if required, to prove its authenticity.

As described above, holder 106 may also commit proof of ownership of the object to ledger 200. Holder 106 may also include additional information about asset 104 that does not include certain secret information (e.g., contributed by expert 102). For example, holder 106 may include a brief description of asset 104 and/or one or more low resolution images of asset 104. These and other data may also be committed to digital ledger 200. Furthermore, ledger 200 may include one or more smart contracts associated with asset 104. For example, ledger 200 may include a smart contract 130 (represented, e.g., as a separate but related chain of blocks) for transferring ownership of asset 104 contingent on confirmation of the identity of asset 104. That is, when a possessor of asset 104 submits a successful request for confirmation of identity, smart contract 130 of ledger 200 may function automatically to transfer title and/or other rights pertaining to asset 104. In this way, all parties can be assured that a purchaser is purchasing the same asset 104 whose “fingerprint” is committed to ledger 200 and associated with a chain of title (or other proof of ownership) for asset 104. In some examples, the transfer of ownership is a separate step that is enabled by a successful request for confirmation of identity, rather than being automatic.

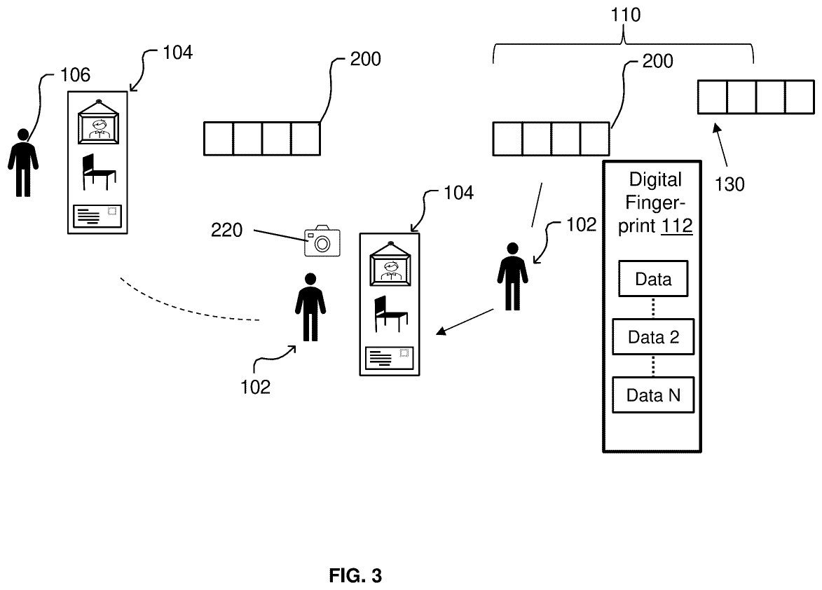

FIG. 3 shows an example of transferring ownership of asset 104 from one holder 106 to custodian 108 using the distributed digital ledger 200, upon identifying asset 104. In some examples, the functions of transferring ownership discussed herein are performed by, or with the aid of, evaluation system 110. According to an example, distributed ledger 200 includes owner information, any applicable secret information about asset 104 (e.g., included and recorded as a digital fingerprint in ledger 200), and may be signed by expert(s) 102. Subsequently, asset 104 comes into the possession of another person, who may be a custodian 108 subsequent owner. Before transferring ownership of asset 104, the custodian 108 may attempt to confirm the identity of asset 104. Custodian 108 may seek confirmation that asset 104 in his/her/its possession is the same asset 104 that is described on ledger 200 and known to be lawfully in the custody of holder 106. Custodian 108 (by himself and/or with the assistance of experts 102) may examine asset 104 for unique characteristics. Custodian 108 may then submit these characteristics as a response to a challenge, and/or as a request to the evaluation system 110, to evaluate against the stored (and encrypted) fingerprint of asset 104. Evaluation system 110, including or having access to the key used to originally encrypt the fingerprint, decrypts the fingerprint and compares the request (and, particularly, the submitted characteristics) to the stored characteristics of asset 104 within the digital fingerprint. In some embodiments, a successful identification requires matching a threshold number of unique characteristics or a matching a threshold percentage of characteristics (e.g., at least three out of four submitted characteristics). In some cases, the request itself may also be committed to the distributed ledger 200.

In some examples, the distributed ledger 200 may include a smart contract 130 associated with ownership transfer(s). Smart contract 103 may automatically execute a transfer of rights from holder 106 to another party when certain conditions are met. For example, smart contract 130 may require a successful identity confirmation and a signature (or other indication of acceptance or agreement to transfer ownership) of custodian 108. In some examples, smart contract 103 may also require payment by custodian 108 (e.g., via conventional currency and/or other instruments such as a cryptocurrency) to submit a request for evaluation. Thus, the custodian 108 could acquire title to asset 104 with a single submission to the evaluation system 110 that also includes a signature and form of payment. Furthermore, the transaction can be performed remotely and without contemporaneous involvement of the holder 106. The holder 106, having previously recorded proof of ownership on ledger 200, a secret “fingerprint” of asset 104, and/or smart contract 103, can merely provide asset 104 to custodian 108 where desirable and/or applicable. Custodian 108 (e.g., upon becoming the next holder 106), in turn, and after examining the received asset 104 for unique characteristics, can cause the execution of smart contract 103, thus transferring applicable rights. Thus, evaluation system 110 provides a technical improvement to the problem of remotely, effectively, and efficiently transferring ownership of objects having unique characteristics.

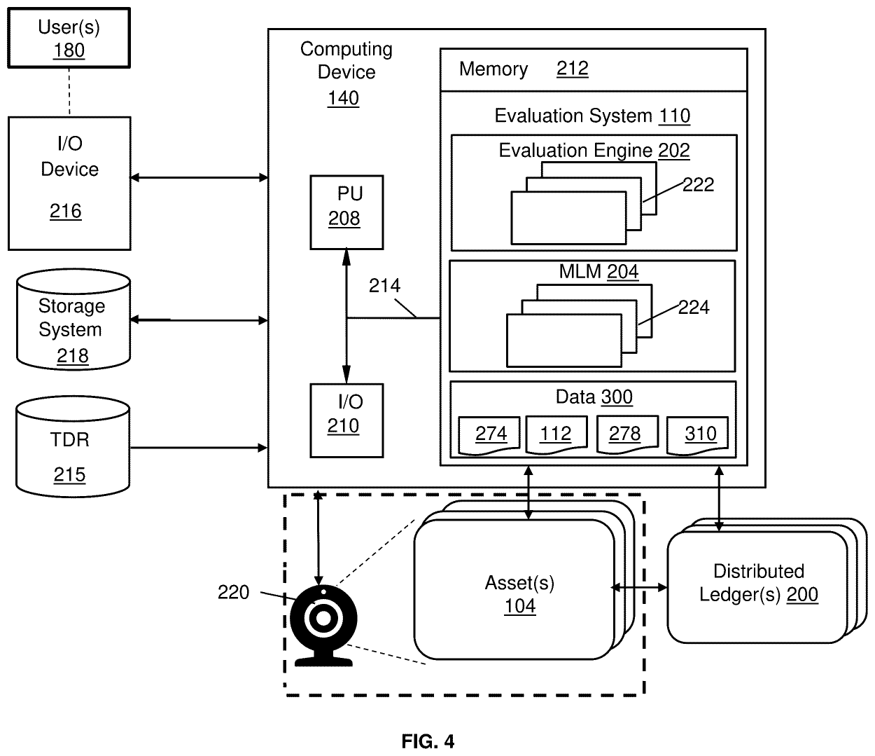

Turning to FIG. 4, embodiments of the disclosure may be implemented using a computing device 140. Computing device 140 may be in communication with one or more image sensors (simply “sensor” hereafter) 220, sensor(s) 220 may be structurally integrated into computing device 140 (or vice versa) and/or other components described herein (e.g., various devices in communication with sensor(s) 220), and/or may be an independent component connected to one or more devices within a team of sensor(s) 220 operating within an environment. Each sensor 220 may be, or may be included within, e.g., a camera, phone, tablet, and/or other currently known or later developed hardware operable to capture image(s) of asset(s) 104 for analysis. One sensor 220 is shown in the schematic depictions provided in FIGS. 1-4, but any number of sensors 220 may be used. Computing device 140 may include a processor unit (PU) 208, an input/output (I/O) interface 210, a memory 212, and a bus 214. Further, computing device 140 is shown in communication with an external I/O device 216, a storage system 218, and a training data repository (TDR) 215. External I/O device 216 may be embodied as any component for allowing user interaction with computing device 140. User(s) 180 of computing device 140 may include any one or more entities described herein, e.g., expert(s) 102, holder(s) 106, and/or custodian(s) 108. Memory 212 may include evaluation system 110. Evaluation system 110 in turn may include an evaluation engine 202 and/or a machine learning model 204 (e.g., any currently known or later developed image recognition model(s)). Evaluation engine 202 may be wholly or partially within memory 212 of computing device 140 and/or other storage system/components herein. In some implementations, sensor(s) 220 may be included within one or more computing devices 140, e.g., where computing device 140 refers to a tablet, smartphone, etc.

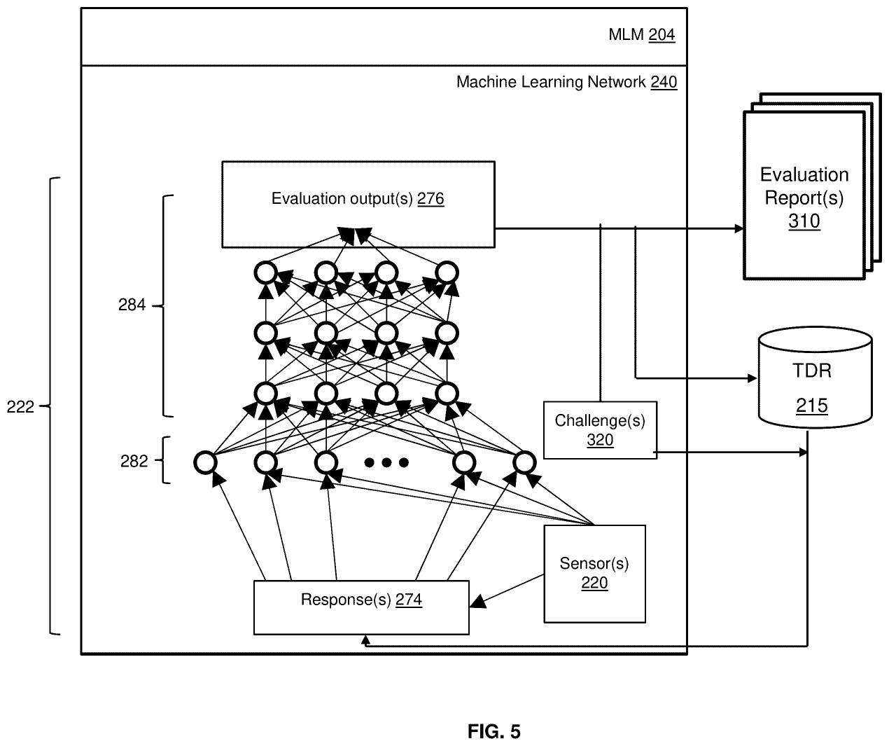

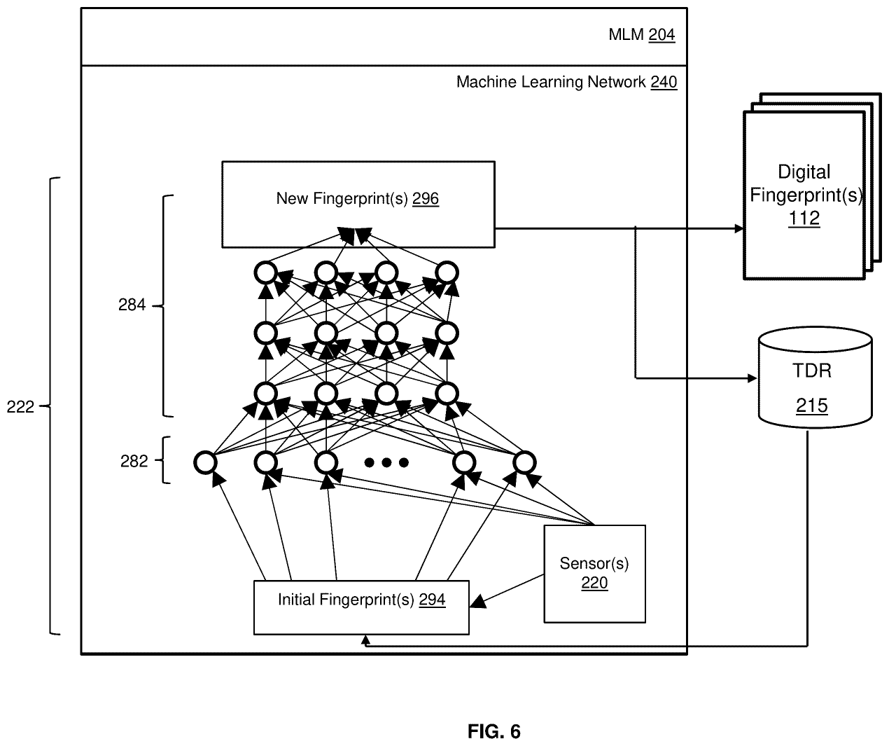

Evaluation engine 202, as discussed herein, may be configured to evaluate (i.e., evaluate as genuine or non-genuine, assess economic value, condition, and/or other attributes, etc.) of asset(s) 104 (including, e.g., determining whether asset(s) 104 are authentic, inauthentic, etc.). Evaluation engine 202 may operate via sensor(s) 220, module(s) 222, and/or may interact with MLM 204, to evaluate asset(s) 104. In some cases, the outcomes of such analysis may be and/or stored on distributed ledger 200. Evaluation engine 202 is further operable to create and/or modify digital fingerprint(s) 112 to aid in analysis of various asset(s) 114. Evaluation system 110 can execute or otherwise govern the operation of evaluation engine 202 and MLMs 142. Evaluation engine 202 may include various modules 222, e.g., one or more software components configured to perform different actions, including without limitation: a calculator, a determinator, a comparator, etc. Similarly, MLM(s) 142 may be executed via an evaluation engine 202 and/or otherwise may be in communication therewith. MLM 204 may have its own modules 224 for implementing various functions, e.g., machine learning operations. Modules 224 of may include any of the example subcomponents discussed herein, e.g., ANNs 240 (FIGS. 5, 6).

Modules 222, 224 can implement various techniques to evaluate asset(s) 104 and/or representations (e.g., images, videos, non-visual recordings such as audio, etc.) of asset(s) 104 as discussed herein. As shown, computing device 140 may be in communication with sensor(s) 220 (or may be implemented on a device including one or more of sensors 220) and can send and/or receive various forms of data to implement the functions of evaluation engine 202. Thus, computing device 140 in some cases may operate as a part of each sensor 220, while in other cases the same computing device 140 may be connected to or included within an intermediate component (e.g., a central or intermediate device) between two or more sensors 220.

Modules 222, 224 of evaluation engine 202 can use calculations, look up tables, and similar tools stored in memory 212 for processing, analyzing, and operating on data to perform their respective functions. In general, PU 208 can execute computer program code, such as evaluation engine 202, which can be stored in memory 212 and/or storage system 218. While executing computer program code, PU 208 can read and/or write data to or from memory 212, storage system 218, and/or I/O interface 210. Bus 214 can provide a communications link between each of the components in computing device 140. I/O device 216 can include any device that enables a user to interact with computing device 140 or any device that enables computing device 140 to communicate with the equipment described herein and/or other computing devices. I/O device 216 (including but not limited to keyboards, displays, pointing devices, etc.) can be coupled to sensor(s) 220/computing device 140 either directly or through intervening I/O controllers (not shown).

Memory 212 can include a cache of data 300 organized for reference by evaluation engine 202. As discussed elsewhere herein, computing device 140 can send, receive, and/or rely on various types of data 300, including metadata pertaining to other object(s) 104, sensor(s) 220, etc. Data 300 thus may be classified into multiple fields and, where desired, sub-fields within each field of data 300. Data 300 may be provided to and/or from sensor 220, e.g., via I/O device 216 and/or other physical or wireless data couplings. To exchange data between multiple sensors 220, computing device 140 may be communicatively connected to other communication features of sensor(s) 220 (I/O interface 210 and/or I/O device 216). In some cases, these communication features may also be contained within memory 212 of computing device 140.

Data 300, as noted, can optionally be organized into a group of fields. In some cases, data 300 may include various fields for cataloguing different types of image(s) 274 previously processed by and/or output from sensor(s) 220. Data 300 also may include digital fingerprint(s) 112 (e.g., any digital fingerprints previously generated and/or other referenced appraisals for the same asset and/or similar asset(s) 104, modified versions of these and/or other digital fingerprints whether automatic or manually created, used as inputs to evaluation engine 202) and/or other data from past instances of implementing methods of the disclosure discussed herein. Data 300 also may be organized into separate fields for evaluation outputs 278 created via MLM 204 and/or evaluation engine 202, and/or evaluation reports 310 indicating responses to other challenges and/or their results, which optionally may be recorded on distributed ledger 200 and/or enriched with other cross-referenced information discussed herein. One or more fields of data 300 may further be catalogued within TDR 215 and/or storage system 218. Each type of data 300, however embodied, may be accessible to evaluation system 110 and/or MLM 204, either or each of which in turn may operate as a sub-program within evaluation engine 202. Data 300 may be mixed and parsed using evaluation engine 202 as it interfaces with a local static database, e.g., via the internet, to store and/or retrieve relevant data from other operating settings, e.g., other asset(s) 104, other representations of asset(s) 104 obtained from different sensors 220, etc. Evaluation system 110 thus may output compressed data 300 to user(s) 180 and/or MLM 204 via networks 100 and/or via other types of connections.

Computing device 140, and/or sensor(s) 220 included within computing device 140 thereon, may comprise any general purpose computing article of manufacture for executing computer program code installed by a user (e.g., a personal computer, server, handheld device, etc.). However, it is understood that computing device 140 is only representative of various possible equivalent computing devices that may perform the various process steps of the disclosure. To this extent, in other embodiments, computing device 140 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. In one embodiment, computing device 140 may include a program product stored on a computer readable storage device, which can be operative to perform any part of the various operational methodologies discussed herein.

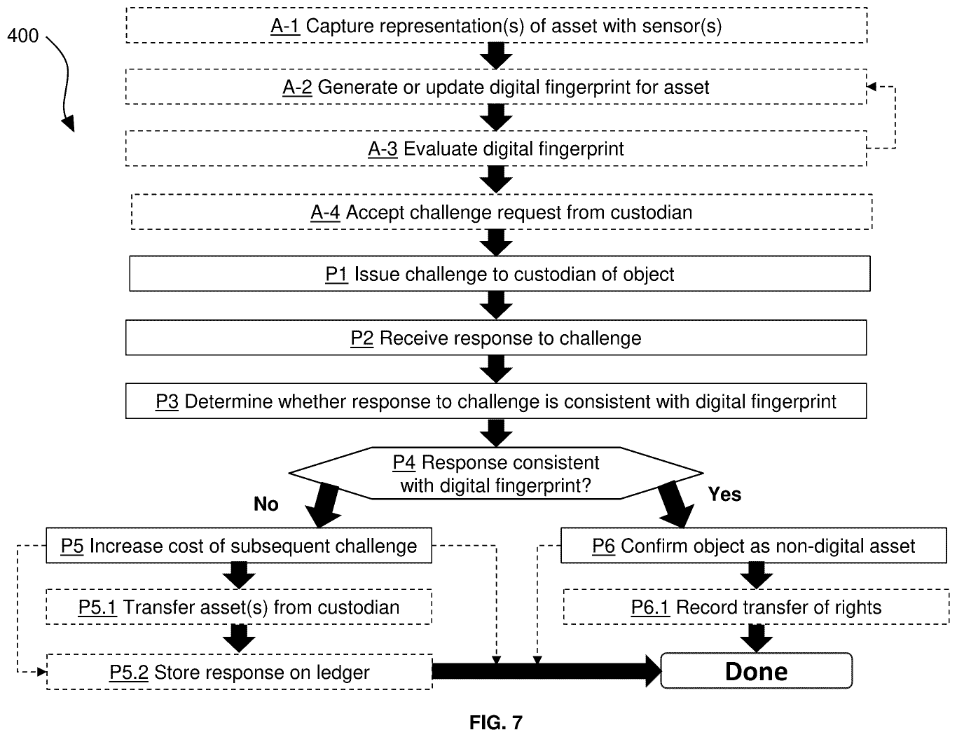

Referring to FIGS. 3 and 4 together, various functions of evaluation system 110 may be implemented via one or more machine learning networks (MLMs) included within and/or otherwise in cooperation with modules 222 of MLM(s) 142. MLMs 142 may include, e.g., any mathematical or algorithmic object capable of estimating an unknown function. A neural network is one example of a component that may be implemented as, or within, modules 222. An example of a machine learning network 240 of module(s) 222 is shown via a schematic diagram to further illustrate processes for generating output(s) 276, i.e., indications of whether a response to a challenge issued by custodian(s) 108 of asset(s) 104 indicates that a particular object has characteristics consistent with a set of corresponding characteristics of digital fingerprint 112. Machine learning network(s) 240 within MLM 204 can relate one or more input variables (e.g., response(s) 274 to challenge(s) 320 issued, e.g., by custodian(s) 106) and/or incoming image data from sensor(s) 220. Response(s) 274 may include live audio or visual feeds, and/or data produced from past uses of sensor(s) 220 and/or past instances of implementing methods described herein and/or with sensor(s) 220 therein. Further examples of response(s) 274 and information therein are discussed regarding methods of the disclosure (e.g., regarding FIG. 7).

A layer of inputs 282 includes, e.g., response(s) 274, audio and/or visual inputs whether provided via sensor(s) 220 or otherwise obtained, and/or other information transmitted to evaluation system 110 via I/O interface 210 and/or device 216. Inputs 282 can together define multiple nodes. Each node and respective input 282 may be connected to other nodes in a hidden layer 284, which represents a group of mathematical functions. In embodiments of the present disclosure, inputs 282 can include, e.g., response(s) 274 submitted by reference to one or more corresponding challenge(s) 320 requesting further information to evaluate asset(s) 104. Each node of hidden layer 284 can include a corresponding weight representing a factor or other mathematical adjustment for converting input variables into output variables. MLM 204 may additionally or alternatively receive data from sensor(s) 220 for immediate processing as part of the layer of input(s) 282. However, it is understood that other input(s) from sensor(s) 220 and/or response(s) 274 also may additionally or alternatively be included in hidden layer 284 in other implementations.

In embodiments of the disclosure, evaluation output(s) 276 can indicate whether asset(s) 104 is/are authentic, an appraised value, and/or other relevant valuation features. For instance, evaluation output(s) 276 may include a listing of asset(s) 104 cross-referenced with response(s) 274 used for analysis, images provided from sensor(s) 220, an appraised value, a listing of techniques and/or reference material(s) used in the appraisal, similar appraisal(s) for comparison, etc. Where desired or applicable, evaluation output 276 can be included within evaluation report 310 or asset(s) 104 under analysis, and/or recorded to distributed ledger 200 (FIG. 3) in communication with evaluation system 110. evaluation output(s) 276 additionally or alternatively may be stored for future use, e.g., in memory 212, TDR 215, etc.

Module(s) 222 of MLM 204 may include, or take the form of, any conceivable machine learning system, and examples of such systems are described herein. In one scenario, module(s) 222 of MLM 204 may include or take the form of a machine learning network 240, and more specifically can include one or more sub-classifications of machine learning network architectures (e.g., a fully connected neural network, convolutional neural network, recurrent neural network, and/or combinations of these examples and/or other types of artificial neural networks), whether currently known or later developed.

FIGS. 3 and 5 depict further and/or optional features that may be provided via MLM 204, apart from analysis and processing of response(s) 274 to challenges. As discussed, evaluation system 110 may include digital fingerprint(s) 112 in data 300, e.g., a set of criteria including physical features, color, sounds, and/or other descriptive or quantifiable features of particular asset(s) 104. MLM 204 may be operable to assess or improve the quality of digital fingerprint(s) 112 in various implementations. For example, one or more digital fingerprint(s) 112 may be provided to input layer 282 MLM 204 as initial fingerprint(s) 294 for certain asset(s) 104. Hidden layer(s) 284 may cross-reference initial fingerprint(s) 294 to other data, e.g., from TDR 215, inputs from sensor(s) 220, and/or other digital fingerprints for other asset(s) 104 with similar or distinct characteristics. This process may include evaluating whether certain properties, such as colors, sizes, shapes, serial numbers, etc., of asset(s) 104 should be included within digital fingerprint(s) 112 for asset(s) 104. MLM 204 thus may output new fingerprint(s) 296 for possible inclusion in data 300 as an additional fingerprint(s) 112, or alternatively, for inclusion in TDR 215 for further training of MLM(s) 204. New fingerprint(s) 296 in some cases may be an updated version of previously existing digital fingerprint(s) 112, in which case, new fingerprint(s) 296 may replace earlier versions of certain digital fingerprint(s) 112. The updating and/or replacing of certain digital fingerprint(s) 112 may be based on, e.g., determining whether new fingerprint(s) 296 are of a higher quality (e.g., they may include more data and/or more relevant data for certain known classifications or subclassifications).

Referring to FIGS. 4 and 7 together, in which FIG. 7 shows an illustrative flow diagram of an example process flow, methods according to the disclosure are discussed. Flow diagram 400 in particular may provide a method for confirming the identity of a particular object is, or is not, a known asset 104. Methods of the disclosure may be applicable to any asset(s) 104 having proof of ownership, title, rights of possession, or other proof of rights related to asset 104. In some examples, such proof of rights may be immutably stored (in digital form) on distributed ledger 200, such as a blockchain. Examples of proof of ownership include title documents, bills of sale, inventory records, and so forth. The proof of ownership may include owner information, such as an identifier, as well as object information which may include a brief description and/or (low-resolution) images of asset(s) 104. Proof of rights to possess may include a title, deed, bequest, and/or other legal instrument such as contract (for instance, a consignment agreement).

Processes A-1, A-2, A-3, and A-4 relate to optional preliminary steps for preparing asset(s) 104 for further interaction with evaluation system 110. It is understood that some or all of processes A-1, A-2, A-3, and/or A-4 may be omitted, implemented by third parties, and/or modified or carried out in different orders. Process A-1 may include, e.g., capturing one or more representation(s) of a known asset 104, evaluated as genuine. Such capturing may include using sensor(s) 220 to create audio and/or visual representations of asset 104 for future reference when evaluating responses to a challenge. These representations may be enhanced via direct user inputs and/or further attributes provided via MLM 204. In addition, the representation(s) of asset(s) 104 may come from one or more experts 102 who have examined asset(s) 104 to determine particular characteristics of asset(s) 104 that can serve to uniquely identify asset(s) 104.

Process A-2 may include compiling one or more aggregate sets of characteristics for particular asset(s) 104 into one or more corresponding digital fingerprints 112 for assets 104. Each digital fingerprint 112 may include known and/or unknown attributes against which the possible identity of an object purporting to be asset(s) 104 can be evaluated at future times. In some examples, the method may include process A-3 assessing the quantity and/or type of characteristics provided in digital fingerprint(s) 112 and/or by expert(s) 102 to determine the strength or effectiveness of digital fingerprint(s) 112. The effectiveness of digital fingerprint(s) 112 may be evaluated according to any suitable metric, e.g., Shannon entropy or other indication of information content of a data vector. For example, process A-3 may include using MLM 204 to treat characteristics such as weight or dimensions as fewer effective identifiers than, e.g., high-resolution images of particular flaws, damage, wear pattern(s), or other more highly unique characteristics. In this case, MLM 204 may also include applying a weight to each received characteristic, the weight based on the type of characteristic(s). Still further, MLM 204 in process A-3 may include comparing a sum of the weights against a threshold. Where evaluation system 110 determines that the weighed sum fails to satisfy the threshold, process A-3 may conclude by returning to process A-2, e.g., requesting additional information from the expert(s) 102, sensor(s) 220, etc. Process A-2, and A-3 where applicable, may include encrypting and storing relevant information about the object's characteristics on distributed ledger 200, thus creating an immutable record of the object's digital fingerprint on the same ledger 200 that includes the proof of ownership.

The methodology may pause following process(es) A-1, A-2, A-3 before, e.g., process A-4, optionally receiving a command or request to issue a challenge to custodian(s) 108 of asset(s) 104. The request may be initiated by any party, particularly those having a property interest in the ownership or transfer of asset(s) 104 in a particular transaction. In some cases, further operations (process P1 et seq. discussed herein) may be initiated without any request, input, etc., and/or may be triggered automatically via particular circumstances identified by evaluation system 110. In cases where process A-4 is implemented, incoming requests may include one or more characteristics of asset(s) 104 that is purported to be the object whose digital fingerprint 110 is recorded on distributed ledger 200. The request(s) may come from custodian(s) 108 of asset 104, and/or any entity that is able to examine and identify characteristics of asset 104 similarly to how digital fingerprint(s) 112 is/are created in processes A-2, A-3. In still further examples, the requests may originate from custodian(s) 108 in the form of law enforcement officials or entities, e.g., attempting to return a lost or stolen asset 104 to a lawful possessor.

To reduce or even minimize the instance of false negative and false positive matches, processes A-2, A-3 may include processing the raw measurement values of the set of characteristics. Such processing may include machine-learning assisted updating of data (e.g., using MLM 204 of evaluation system 110, and/or modules 222 of evaluation engine 202) to remove artifacts, irrelevant data, measuring variations, etc. Such removing of noise, measuring variations, and/or irrelevant data created in the measurement process would otherwise be difficult to manually avoid or remove in practice, e.g., without rare and costly measurement equipment. The adjusting and/or updating of raw measurement values may be integrated into any or all of the generating of digital fingerprint 110, the evaluating of digital fingerprint 110, or the updating of digital fingerprint 110 relative to any asset(s) 104.

At process P1, the method includes comparing characteristics identified in a response to the challenge against digital fingerprint(s) 112 for asset(s) 104 as previously recorded on distributed ledger 200. Process P1 may further include, for each of the requests, comparing certain identified characteristics previously recorded on distributed ledger 200 but unknown to custodian(s) 108. In some examples, the method includes determining that a threshold number of identified characteristics correspond to various previously recorded characteristic of digital fingerprint(s) 112. For some classes of characteristics, determining that an identified characteristic matches or corresponds to corresponding characteristic(s) of digital fingerprint 112 may include determining an exact or near-exact match. Some other classes of characteristics, (e.g., in the case of measured characteristics, such as weight) determining that an identified characteristic corresponds to digital fingerprint 112 may include determining that the identified characteristic is sufficiently close to the previously recorded value, such as within a measurement margin of error and/or a fixed threshold, such as 5%, 10%, etc. of quantifiable property (e.g., height, weight, etc.) In some examples, the method includes determining that a percentage of total listing of identified characteristics in distributed ledger 200 correspond to the previously recorded characteristics in digital fingerprint(s) 112.

In process P3, the method includes determining whether response(s) submitted to evaluation system 110 are consistent with digital fingerprint 112. Such determinations may be based on, e.g., one or more of the criteria discussed herein regarding process P2. Process P4 causes the method to continue to process P5 or process P6 based on whether the response is consistent with digital fingerprint 112 for asset(s) 104. In the case where the response is not consistent with digital fingerprint 112 (e.g., a threshold number, percentage, and/or other threshold of corresponding characteristics is not satisfied), i.e., “No” at process P4, the method may implement process P5. Process P5 includes increasing the cost to process a subsequent challenge and response for asset(s) 104 or other asset(s) 104. Escalating the cost of future confirmation requests may deter bad actor(s) attempting to guess characteristics of asset(s) 104 despite not actually having possession of asset(s) 104 evaluated as genuine. The amount of increase to cost may be solely monetary (e.g., if each request has an associated cost), time-based, and/or any further manner of increasing the value needed to process a subsequent response to a challenge. For instance, after an unsuccessful response to the challenge issued, the system may require an escalating amount of time to pass before accepting a subsequent request for confirmation.

In the case where increases to the cost of subsequent challenges is non-monetary, the first request may impose no further delay, or merely a nominal delay. For subsequent requests, evaluation engine 202 of evaluation system 110 may impose a delay or cost that is greater than the previously imposed delay or cost. In some examples, modules 222 of evaluation engine 202 may increase the delay or cost as a function of the strength of digital fingerprint 112. For example, the imposed delay or cost may escalate more quickly if digital fingerprint 112 is based on a small number of different characteristics. In some cases, modules 222 may increase the delay or cost exponentially with each request. For example, for digital fingerprints 112 based on a large number of characteristics, the imposed delay or cost may increase exponentially (e.g., double) after each unsuccessful request. For digital fingerprints 112 based on a smaller number of characteristics (or aggregate characteristics having a lower Shannon entropy), the imposed delay or cost may increase by a factor of ten (or more) after each unsuccessful request.

In addition to (or in lieu of) the imposed delay, each subsequent request may be solely monetary. For example, each request may require an associated payment (e.g., via a digital wallet) from one party to another. In some circumstances, process P5 may include process P5.1 of transferring one or more monetary assets (e.g., currency, cryptocurrency, and/or other items held as payment or collateral) from custodian 108 to the operator(s) of evaluation system 110. The payment requirement may escalate in a similar manner to the escalating time delay described above. In some examples, a first request may be free or relatively low cost, but subsequent requests may require escalating payments. These automatic and escalating costs provide a technical and monetary solution for disincentivize random guessing by people who are not actually in possession of asset(s) 104, and/or otherwise cover the processing costs of repeated requests, while supporting legitimate online, remote, and seamless transfer of non-digital assets. Yet another optional process P5.2 may include, e.g., storing the response(s) to the challenge(s) on ledger 200 even when such responses are not successful. This may prevent or otherwise reduce the processing time to evaluate identical or substantially similar subsequent requests. If no further responses are provided to evaluation system 110, the method may conclude (“Done”) following process(es) P5, P5.1, P5.2 where applicable.

Where the response is determined to be consistent with digital fingerprint 110 (i.e., “Yes” at process P4) the method may continue to process P6 to confirm the object under analysis as being asset(s) 104. Optionally, upon implementing process P6, the method also may include process P6.1 of automatically recording the confirmation and/or a transfer of rights on ledger distributed ledger 200. Process(es) P6, P6.1 may also or alternatively include recording, on distributed ledger 200, the request that resulted in a match. In some examples, evaluation system 110 may be operable to record all requests, successful or not, on distributed ledger 200. The requests may be encrypted to avoid “leaking” information that could be used to guess characteristics of asset(s) 104. In some examples, after the evaluation system 110 determines that there is a match, the evaluation engine 202 may be operable to suspend further confirmations until after receiving additional information to “refresh” digital fingerprint 112 (e.g., as generated by modules 222, generated via MLM 204, and/or recorded on ledger 200). In some cases, this may include requesting additional information from experts 102 and/or user(s) 180, such as additional characteristics of asset 104 and/or data from sensor(s) 220 that can be used to refresh digital fingerprint 112. The method may then include reassessing the quantity and/or type of characteristics provided by the expert to determine the effectiveness of digital fingerprint 112, and/or may include requesting additional information from the expert(s) 102 or other users 180 if the determined level of effectiveness fails to satisfy a threshold. That is, process(es) A-1, A-2, A-3, and/or A-4 may be repeated. For example, if the strength of digital fingerprint(s) 112 (e.g., the Shannon entropy is or becomes below a threshold level) is considered too low, the method may include resetting the cost of subsequent requests to a baseline after refreshing digital fingerprint(s) 112. In some examples, the method may include reassessing and, if needed, requesting new information and refreshing digital fingerprint 112 each request, not merely after a successful match as part of process P6.

In some examples, the method includes process P6.1 of transferring certain rights (such as ownership) of asset 104 to custodian(s) 108 after confirming the identity of asset(s) 104 in process P6. For example, the response to the challenge optionally may also include a request for transfer of ownership and/or other rights to custodian 108. In this case, process P6.1 may include, after determining that the request sufficiently matches digital fingerprint 112, transferring ownership and/or other rights in asset(s) 104. In some examples, distributed ledger 200 includes one or more smart contracts 130 (FIGS. 1-3). Smart contracts 130 may include terms that require confirming the identity of asset(s) 104 using digital fingerprint(s) 112 and/or evaluation system 110 as a condition for transferring ownership. When all conditions of smart contract 130 have been met, the method may include automatically transferring rights in asset 104 to custodian(s) 108. The method may further include recording the transfer of ownership on distributed ledger 200. In some examples, the method includes recording a new or modified smart contract 130 on distributed ledger 200 for transferring ownership of asset 104 to another party. In some examples, the method includes refreshing digital fingerprint 112 and/or resetting the escalating cost to a baseline after the transfer of ownership. These (and other) actions may be automatically performed by the smart contract 130 alone or in combination with evaluation system 110.

Embodiments of the disclosure provide various technical and commercial advantages, examples of which are discussed herein. By implementing systems and methods of the disclosure, it is possible for various people, organizations, etc. (e.g., groups of users 180 including experts 102, lawful holders 106, custodians 108, etc.) to evaluate and/or authenticate items without necessarily having to be present and/or having to manually survey all aspects of the item to determine whether it/they are asset(s) 104. Moreover, embodiments of the disclosure can improve the quality of appraisals by providing an immutable encrypted record of current and past owners via distributed ledger 200. Still further, methods of the disclosure may allow ownership rights to transfer quickly or even automatically to custodian(s) 108 of asset(s) 104 upon its evaluation. Embodiments of the disclosure also may impede or prevent double sales of the same asset(s) 104, sales of inauthentic asset(s) 104, etc.

In the disclosure, an “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “computer-readable medium,” “data storage,” “data storage facility,” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

A “machine learning model” or a “model” refers to a set of algorithmic routines and parameters that can predict an output(s) of a real-world process (e.g., identification or classification of an object) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology. A machine learning model may be trained on a sample dataset (referred to as “training data”).

A distributed ledger (also called a shared ledger or distributed ledger technology or DLT) is a system whereby replicated, shared, and synchronized digital data is geographically spread (distributed) across many sites, and consequently does not have a single (central) point-of-failure. In general, a distributed ledger requires a peer-to-peer (P2P) computer network and consensus algorithms so that the ledger is reliably replicated across distributed computer nodes. Each node replicates and saves an identical copy of the ledger data and updates itself independently of other nodes. Security is generally enforced through cryptographic keys and signatures. Currently, the most common form of distributed ledger technology is the blockchain.

A blockchain is a distributed ledger with growing lists of records (blocks) that are securely linked together via cryptographic hashes. Each block contains a cryptographic hash of the previous block, a timestamp, and transaction data. Since each block contains information about the previous block, they effectively form a chain, with each additional block linking to the ones before it. Consequently, blockchain transactions are irreversible in that, once they are recorded, the data in any given block cannot be altered retroactively without altering all subsequent blocks.

A smart contract is a computer program or a transaction protocol that is intended to automatically execute, control, or document events and actions according to the terms of an agreement. In this way, a smart contract is a self-executing agreement. Smart contracts are commonly associated with cryptocurrencies, and the smart contracts introduced by Ethereum are generally considered a fundamental building block for decentralized finance (DeFi) and non-fungible token (NFT) applications. Similar to a transfer of value on a blockchain, once a smart contract is deployed on a blockchain, it cannot be altered, but the state of a smart contract may change as it executes.

A digital fingerprint includes information collected about an object for the purpose of identification. The information is usually assimilated into a brief identifier using a fingerprinting algorithm that maps arbitrarily large data items to a smaller data structure that uniquely identifies the original data for all practical purposes (similar to how human fingerprints uniquely identify people for practical purposes). Fingerprint functions may be seen as high-performance hash functions used to uniquely identify substantial blocks of data where cryptographic hash functions may be unnecessary. Fingerprint functions may also use cryptographic hash functions to keep the information collected about the device secret. The strength or effectiveness of the fingerprint may be expressed in terms of Shannon entropy. That is, in information theory, the entropy of a variable is the average level of “information,” “surprise,” or “uncertainty” inherent to the variable's possible values.

A “law enforcement official” may include a government agent who is authorized to enforce laws, such as a police officer or judicial system employee. A law enforcement official also may include an employee, contractor or other authorized user of the government agency.

It is appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

It should be understood that various aspects disclosed herein may be combined in different combinations than the combinations specifically presented in the description and accompanying drawings. For example, features, functionality, and components from one embodiment may be combined with another embodiment and vice versa unless the context clearly indicates otherwise. Similarly, features, functionality, and components may be omitted unless the context clearly indicates otherwise. It should also be understood that, depending on the example, certain acts or events of any of the processes or methods described herein may be performed in a different sequence, may be added, merged, or left out altogether (e.g., all described acts or events may not be necessary to carry out the techniques).

The breadth and scope of this disclosure should not be limited by any of the above-described example embodiments but should be defined only in accordance with the following claims and their equivalents.

1. A method comprising:
issuing a challenge to a custodian of an object purported to be a non-digital asset based on a digital fingerprint of the non-digital asset, wherein the digital fingerprint includes a plurality of characteristics for the non-digital asset encrypted and stored on a distributed ledger;
determining whether a response to the challenge includes a predetermined set of characteristics of the object consistent with a set of corresponding characteristics of the digital fingerprint;
in response to determining the predetermined set of characteristics of the object is not consistent with the set of corresponding characteristics of the digital fingerprint, increasing a cost to the custodian to issue a subsequent challenge request for the object; and
in response to determining the predetermined set of characteristics of the object is consistent with the set of corresponding characteristics of the digital fingerprint, confirming the object as being the non-digital asset.

2. The method of claim 1, further comprising generating the digital fingerprint of the non-digital asset by encrypting and storing the plurality of characteristics on the digital ledger.

3. The method of claim 1, further comprising, in response to the predetermined set of characteristics of the object is consistent with the set of corresponding characteristics of the digital fingerprint:
transferring the non-digital asset to the custodian; and
recording a transfer of rights to the non-digital asset on the distributed ledger, wherein the recorded transfer of rights includes a proof of rights transfer.

4. The method of claim 1, further comprising, in response to determining the predetermined set of characteristics of the object is not consistent with the set of corresponding characteristics of the digital fingerprint, transferring an asset from a digital wallet associated with the custodian.

5. The method of claim 1, further comprising:
updating the digital fingerprint to remove data from at least one of processing artifacts, irrelevant data, or measurement variations; and
estimating an effectiveness of the digital fingerprint based on a quantity and/or type of the plurality of characteristics of the non-digital asset included in the digital fingerprint.

6. The method of claim 5, further comprising, in response to the effectiveness of the digital fingerprint not meeting an effectiveness threshold, adding additional characteristics of the non-digital asset to the digital fingerprint.

7. The method of claim 1, further comprising, in response to determining the predetermined set of characteristics of the object is not consistent with the set of corresponding characteristics of the digital fingerprint, storing the response to the challenge on the distributed ledger.

8. A system comprising:
a processor; and
a memory having programming instructions configured to cause the processor to perform actions including:
issuing a challenge to a custodian of an object purported to be a non-digital asset based on a digital fingerprint of the non-digital asset, wherein the digital fingerprint includes a plurality of characteristics for the non-digital asset encrypted and stored on a distributed ledger;
determining whether a response to the challenge includes a predetermined set of characteristics of the object consistent with a set of corresponding characteristics of the digital fingerprint;
in response to determining the predetermined set of characteristics of the object is not consistent with the set of corresponding characteristics of the digital fingerprint, increasing a cost to the custodian to issue a subsequent challenge request for the object; and
in response to determining the predetermined set of characteristics of the object is consistent with the set of corresponding characteristics of the digital fingerprint, confirming the object as being the non-digital asset.

9. The system of claim 8, wherein the program instructions are further configured to cause the processor to generate the digital fingerprint of the non-digital asset by encrypting and storing the plurality of characteristics on the digital ledger.

10. The system of claim 8, wherein the program instructions are further configured to cause the processor to, in response to the predetermined set of characteristics of the object is consistent with the set of corresponding characteristics of the digital fingerprint, record a transfer of rights to the non-digital asset on the distributed ledger after transferring the non-digital asset to the custodian, wherein the recorded transfer of rights includes a proof of rights transfer.

11. The system of claim 8, wherein the program instructions are further configured to cause the processor to, in response to determining the predetermined set of characteristics of the object is not consistent with the set of corresponding characteristics of the digital fingerprint, transfer an asset from a digital wallet associated with the custodian.

12. The system of claim 8, wherein the program instructions are further configured to cause the processor to:
update the digital fingerprint to remove data from at least one of processing artifacts, irrelevant data, or measurement variations; and
estimate an effectiveness of the digital fingerprint based on a quantity and/or type of the plurality of characteristics of the non-digital asset included in the digital fingerprint.

13. The system of claim 12, wherein the program instructions are further configured to cause the processor to, in response to the effectiveness of the digital fingerprint not meeting an effectiveness threshold, add additional characteristics of the non-digital asset to the digital fingerprint.

14. The system of claim 8, wherein the program instructions are further configured to cause the processor to, in response to determining the predetermined set of characteristics of the object is not consistent with the set of corresponding characteristics of the digital fingerprint, store the response to the challenge on the distributed ledger.

15. A program product comprising a computer readable storage medium with program code for causing a computer system to perform actions including:
issuing a challenge to a custodian of an object purported to be a non-digital asset based on a digital fingerprint of the non-digital asset, wherein the digital fingerprint includes a plurality of characteristics for the non-digital asset encrypted and stored on a distributed ledger;
determining whether a response to the challenge includes a predetermined set of characteristics of the object consistent with a set of corresponding characteristics of the digital fingerprint;
in response to determining the predetermined set of characteristics of the object is not consistent with the set of corresponding characteristics of the digital fingerprint, increasing a cost to the custodian to issue a subsequent challenge request for the object; and
in response to determining the predetermined set of characteristics of the object is consistent with the set of corresponding characteristics of the digital fingerprint, confirming the object as being the non-digital asset.

16. The program product of claim 15, further comprising program code for generating the digital fingerprint of the non-digital asset by encrypting and storing the plurality of characteristics on the digital ledger.

17. The program product of claim 15, further comprising program code for, in response to the predetermined set of characteristics of the object is consistent with the set of corresponding characteristics of the digital fingerprint:
transferring the non-digital asset to the custodian; and
recording a transfer of rights to the non-digital asset on the distributed ledger, wherein the recorded transfer of rights includes a proof of rights transfer.

18. The program product of claim 15, further comprising program code for, in response to determining the predetermined set of characteristics of the object is not consistent with the set of corresponding characteristics of the digital fingerprint, transferring an asset from a digital wallet associated with the custodian.

19. The program product of claim 15, further comprising program code for:
updating the digital fingerprint to remove data from at least one of processing artifacts, irrelevant data, or measurement variations; and
estimating an effectiveness of the digital fingerprint based on a quantity and/or type of the plurality of characteristics of the non-digital asset included in the digital fingerprint.

20. The program product of claim 15, further comprising program code for, in response to determining the predetermined set of characteristics of the object is not consistent with the set of corresponding characteristics of the digital fingerprint, storing the response to the challenge on the distributed ledger.
